(19) United States
(12) Patent Application Publication
(10) Pub. No.: US 2025/0317404 A1
(43) Pub. Date: Oct. 9, 2025

(54) INFORMATION PROCESSING DEVICE, INFORMATION PROCESSING METHOD, AND PROGRAM

(71) Applicant: Nippon Telegraph and Telephone Corporation, Tokyo (JP)

(72) Inventors: Koichi HARA, Musashino-shi, Tokyo (JP); Noritaka HORIKOME, Musashino-shi, Tokyo (JP)

(21) Appl. No.: 18/873,022

(22) PCT Filed: Jun. 16, 2022
(86) PCT No.: PCT/JP2022/024146

§ 371 Date: Dec. 9, 2024

(51) Int. Cl. H04L 47/70

(52) U.S. Cl. CPC H04L 47/70

(57) ABSTRACT

A server (10) as an information processing apparatus capable of executing an application of any one of a container and a virtual machine, the server including a CPU (11), a connection IF (13) connecting a plurality of devices (12) to the CPU, a monitoring unit (14) that monitors whether a bandwidth usage of the connection IF exceeds an upper limit, and an adjustment unit (15) that adjusts the bandwidth usage in a case where the usage exceeds the upper limit. In the bandwidth, a logical resource amount is defined and an allocation proportion associated with the device is set based on the logical resource amount, and the adjustment unit performs control such that the bandwidth usage is reduced for a case where a usage proportion of the bandwidth is higher than an allocation proportion.

### TECHNICAL FIELD

The present invention relates to an information processing apparatus, an information processing method, and a program, which adjust a bandwidth usage of an inter-device interface in an orchestration of a container and a virtual machine.

### BACKGROUND ART

In recent years, in server farms such as data centers, virtualization infrastructure is increasingly being constructed and operated. A virtualization platform is a virtual environment that abstracts and hides physical resources such as servers or networks using virtualization technology and is prepared as a common platform for a plurality of applications or services, as well as a system that manages those virtual environments.

Known open source virtualization platforms include OpenStack which is software for constructing cloud environments, and Kubernetes which is software for operating and managing containerized workloads or services. OpenStack is mainly used to manage and operate physical machines or virtual machines (VMs). Kubernetes is mainly used to manage and operate containers. These software are called orchestration software.

Generally, an application executed in a VM or a container makes a request for an amount of physical resource to an Orchestrator (a functional unit for managing a server group composed of a plurality of physical servers). For example, the application requests, for an Orchestrator, how much physical resources are required, such as “3 cores” for the Central Processing Unit (CPU), “4 GB” for the memory, and “1” for the Graphics Processing Unit (GPU). The Orchestrator finds a server satisfying the requested condition among the vacant server groups, and assigns a VM or a container to the found server.

For example, in Kubernetes managing a container, when deploying a Pod including the container, a necessary resource amount (a CPU, a memory, a device or the like) is listed in a manifest file to manage the amount of resources allocated to the Pod (refer to NPL 1). Thus, in Kubernetes, it is possible to prevent occurrences of an allocation exceeding the resource amount.

### CITATION LIST

### Non Patent Literature

[NPL 1] Kubernetes, “GPU scheduling”, [online], [retrieval on May 25, 2022], the Internet <URL: https://kubernetes.io/ja/docs/tasks/manage-gpus/scheduling-gpus/>

### SUMMARY OF INVENTION

### Technical Problem

However, in the orchestration software, the bandwidth of the connection interface (sometimes referred to as “connection IF”) for connecting the CPU and the device cannot be limited as the resource amount. The device here is, for example, a GPU, a field-programmable gate array (FPGA), an application specific integrated circuit (ASIC), a network interface card (NIC), or the like.

For example, a bandwidth of a Peripheral Component Interconnect Express (PCIe) which is generally used at present as an IF connecting a CPU and a device can be considered. The bandwidth of the PCIe may be shared by a plurality of devices connected to the CPU, and the available bandwidth changes depending on the communication state of each device. Therefore, it is impossible to allocate the PCIe bandwidth for each device as an independent resource amount such as a CPU or a memory. Therefore, the bandwidth of the PCIe is not handled as a resource amount and is not managed.

In a situation where a large number of devices are connected to the CPU, since the bandwidth of the connection IF is insufficient, the number of cases of contention increases by the switch, and the throughput of a plurality of applications decreases. That is, in a situation where a large number of devices are connected to the CPU, communication with the CPU competes with other devices, and congestion occurs in the same manner as the network. As a result, the speed will be determined by the bandwidth of the connection IF rather than the performance of the device, and the performance of applications that use the device will deteriorate, causing a problem that performance cannot be guaranteed.

In view of such a problem, the present invention is intended to suppress deterioration in performance of an application due to tight bandwidth of a connection IF connecting a CPU and a device.

### Solution to Problem

An information processing apparatus according to the present invention is an information processing apparatus capable of executing an application of any one of a container and a virtual machine, the apparatus including a CPU, a connection IF for connecting a plurality of devices to the CPU, a monitoring unit that monitors whether a bandwidth usage of the connection IF exceeds an upper limit, and an adjustment unit that adjusts the bandwidth usage in a case where the usage exceeds the upper limit, in which in the bandwidth, a logical resource amount is defined and an allocation proportion associated with the device is set based on the logical resource amount, and the adjustment unit performs control such that the bandwidth usage is reduced for a case where a usage proportion of the bandwidth is higher than an allocation proportion.

### Advantageous Effects of Invention

According to the present invention, it is possible to suppress deterioration in performance of an application due to tight bandwidth of a connection IF connecting a CPU and a device.

### BRIEF DESCRIPTION OF DRAWINGS

FIG. 1 is a diagram illustrating an overall configuration of an information processing system according to the present embodiment.

FIG. 2 is a table indicates a range of logical resource amount that can be set in a bandwidth of a connection IF.

FIG. 3 is a table shows an allocation proportion of a logical resource amount.

FIG. 4 illustrates a flowchart (first device) of an information processing method according to the present embodiment.

FIG. 5 illustrates a flowchart (second device) illustrating an information processing method according to the present embodiment.

FIG. 6 illustrates a flowchart (second) illustrating an information processing method according to the present embodiment.

FIG. 7 is a list of parameters to be set in adjustment processing of a combination system.

FIG. 8 illustrates a flowchart (second device) of an information processing method according to the present embodiment.

FIG. 9 is a diagram illustrating an overall configuration of an information processing system according to a modification example.

FIG. 10 is a hardware configuration diagram illustrating an example of a computer that implements functions of an information processing apparatus according to the present embodiment.

### DESCRIPTION OF EMBODIMENTS

### Outline of Present Invention

First, an overview of processing of the present invention will be described. In the present invention, a logical resource amount is defined in advance in a bandwidth of a connection IF (for example, PCIe) that a server constructing a virtualization base has. The logical resource amount is, for example, a value based on a specification of the server, and is a number without a unit (non-dimensional number). In addition, an allocation proportion associated with a device is set to the defined logical resource amount. The allocation proportion is, for example, a ratio in which the logical resource amount is allocated to each device. A value capable of calculating the allocation proportion may be set, and the allocation proportion may be calculated as necessary. Then, the application is executed, and when the bandwidth usage exceeds the upper limit (in a case where the effective bandwidth reaches the upper limit), the bandwidth usage is adjusted based on the allocation proportion. The device connected to the CPU via the connection IF is not limited to the device owned by the server itself, and may be connected via a network. That is, it is possible to adjust the bandwidth including devices included in other devices.

Next, a mode for carrying out the present invention (hereinafter referred to as “the present embodiment”) will be described.

### Configuration of Information Processing System

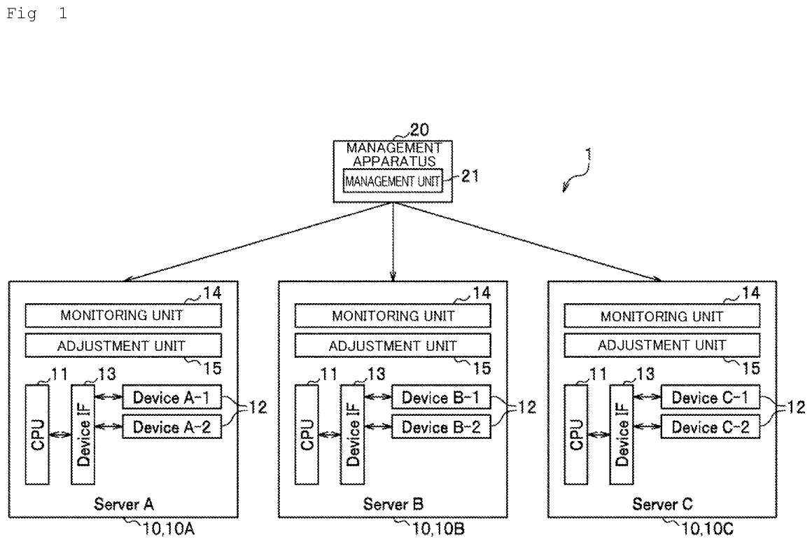

A configuration of an information processing system 1 according to the present embodiment will be described. FIG. 1 is a diagram illustrating an overall configuration of the user information processing system 1 according to the present embodiment.

The information processing system 1 includes a plurality of servers 10 (10A, 10B, and 10C) as physical resources, and a management apparatus 20 communicatively connected to the servers 10. The information processing system 1 is managed by orchestration software (for example, “Kubernetes”) designed to perform operation management and automation of a container or a virtual machine (VM). The orchestration software virtualizes physical resources (here, the server 10) by a virtualization technique, and provides an application by a virtualization resource (container, VM, or the like) set on each server 10. The server 10 is an example of an “information processing apparatus”.

The server 10 includes a CPU 11, a device 12, and a connection IF 13.

The device 12 includes, for example, a GPU, an FPGA, an ASIC, NIC or the like.

The connection IF (Device IF) 13 connects the device 12 to the CPU 11. The connection IF 13 is, for example, PCIe or the like.

The CPU 11 is connected to the device 12 via a connection IF 13. For example, the CPU 11 of a “Server A” which is the first server 10A is connected to a “Device A-1” which is the first device 12 and a “Device A-2” which is the second device 12 via the connection IF 13. In addition, the CPU 11 of a “Server B” which is a second server 10B is connected to a “Device B-1” which is the first device 12 and a “Device B-2” which is the second device 12 via the connection IF 13. In addition, the CPU 11 of a “Server C” which is a third server 10C is connected to a “Device C-1” which is the first device 12 and a “Device C-2” which is the second device 12 via the connection IF 13.

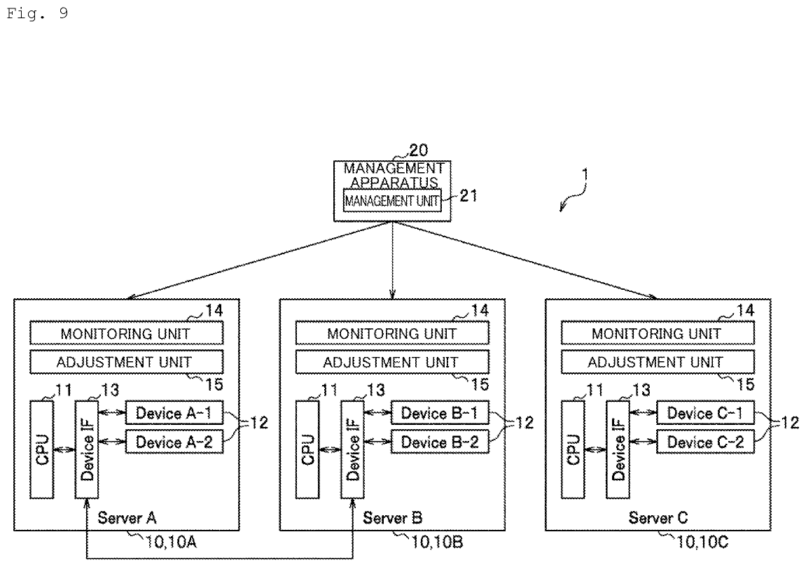

As illustrated in FIG. 9, the CPU 11 may be connected to the device 12 included in another server 10 via the connection IF 13 and a network. In the configuration illustrated in FIG. 9, the CPU 11 of the “Server A” which is the first server 10A is connected to the “Device A-1” which is the first device 12 owned by itself and the “Device A-2” which is the second device 12 via the connection IF 13, and further, is connected to the “Device B-1” which is the first device 12 of the “Server B” which is the second server 10B and the “Device B-2” which is the second device 12 via a network.

In addition, as illustrated in FIG. 1, the server 10 includes a monitoring unit 14 and an adjustment unit 15. The monitoring unit 14 and the adjustment unit 15 are realized by executing a program of orchestration software.

The monitoring unit 14 monitors the bandwidth usage of the connection IF 13. For example, the monitoring unit 14 can monitor the bandwidth usage of the connection IF 13 in a device unit. The monitoring unit 14 notifies the adjustment unit 15 that the bandwidth usage (effective bandwidth) of the connection IF 13 exceeds the performance upper limit of the connection IF 13 (may exceed the performance upper limit).

The adjustment unit 15 performs control to adjust the bandwidth usage in a case where the bandwidth usage (effective bandwidth) of the connection IF 13 exceeds the upper limit of performance of the connection IF 13 (even if there is a risk of exceeding the performance limit).

In this case, a logical resource amount is defined in the bandwidth of the connection IF 13. The logical resource amount is, for example, a parameter that can be set by a manager of the information processing system 1, a minimum value and a maximum value are determined, and the manager set a numerical value within the range based on specifications of the server 10 (in particular, specifications of the connection IF 13).

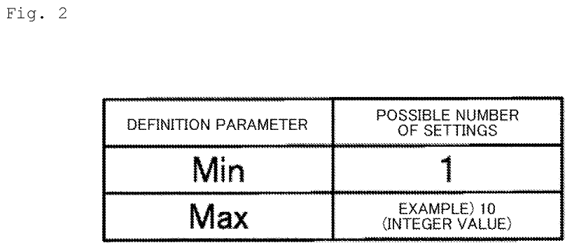

For example, the manager sets the logical resource amount based on the information illustrated in FIG. 2. FIG. 2 is a table showing the range of logical resource amount settable in the bandwidth of the connection IF 13, and an integer value within the range of “1 to 10” can be set as the logical resource amount. The logical resource amount set in the bandwidth of the connection IF 13 may be, for example, a relative value (relative performance ratio) based on a specific server, and in that case, the amount of logical resources is a unitless number (dimensionless number). In a case where the specifications of the server 10 are the same, the logical resource amount may be a specified value. The logical resource amount is registered, for example, in a management unit 21 of the management apparatus 20. In this case, the maximum value “10” is set as the logical resource amount in the bandwidth of the connection IF 13 of the “Server A” which is the first server 10A.

In addition, the creator of the application (called “user”) sets the allocation proportion associated with the device 12. The allocation proportion is set based on a logical resource amount set in a bandwidth of the connection IF 13. A value capable of calculating the allocation proportion may be set, and the allocation proportion may be calculated as necessary.

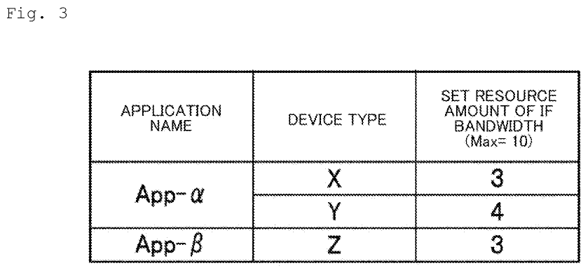

An example of the allocation proportion is illustrated in FIG. 3. FIG. 3 is a table showing the allocation proportion of the logical resource amount. The table illustrated in FIG. 3 has items of “Application Name”, “Device Type”, and “Set resource amount of IF bandwidth”. The table illustrated in FIG. 3 is registered in the management unit 21. For example, the information of the application is registered in each application, and the application notifies the management unit 21 of the information of the application (a part of the information may be notified) when the application is deployed.

The “Application Name” is information for identifying an application. In FIG. 3, “App-α” as the first application and “App-β” as the second application are registered.

The “Device Type” is information related to the type of the device 12 used in the application. In FIG. 3, the device types “X, Y” are registered as the device 12 used in the first application “App-α”, and the device type “Z” is registered as the device 12 used in the second application “App-β”. The device type is information capable of distinguishing for example, a GPU, an FPGA, an ASIC, and a NIC.

The “set resource amount of the IF bandwidth” is information related to the bandwidth of a connection IF 13 used in an application. In FIG. 3, “3” is registered as the logical resource amount for the device type “X” used by the first application “App-α”, “4” is registered as the logical resource amount for device type “Y” used by the first application “App-α”, and “3” is registered as the logical resource amount for device type “Z” used by the second application “App-β”. The “logical resource amount of the IF bandwidth” is set based on the range of the logical resource amount illustrated in FIG. 2. When the container is deployed to the server 10, a bandwidth registered as the “set resource amount of the IF bandwidth” is allocated to the device 12.

In a case where the specifications of the respective servers 10 are the same, only the allocation proportion of the logical resource amount illustrated in FIG. 3 may be set without setting the logical resource amount based on FIG. 2 (that is, setting a specified value as the logical resource amount). Based on FIG. 2, the logical resource amount is set for the bandwidth of each server 10 on the assumption that there is a difference in specifications of each server 10.

The adjustment unit 15 of the server 10 illustrated in FIG. 1 performs control so that the bandwidth usage is reduced with respect to the usage proportion of the bandwidth is higher than the allocation proportion. The ratio of the bandwidth usage and the allocation proportion can be compared in a device unit.

### Description of Processing for Comparing Usage Proportion and Allocation Proportion in Device Unit

The adjustment unit 15 calculates an allocation proportion in a device unit based on the “set resource amount of the IF bandwidth”. For example, in a case where it is assumed that “App-α” and “App-β” are executed in a certain server 10, “ 3/10 (30%)” is calculated as the allocation proportion of the device 12 of the device type “X” used in “App-α”, “ 4/10 (40%)” is calculated as the allocation proportion of the device 12 of the device type “Y” used in “App-α”, “ 3/10 (30%)” is calculated as the allocation proportion of the device 12 of the device type “Z” used in “App-β”. In addition, the adjustment unit 15 acquires the bandwidth usage for each device 12 from the monitoring unit 14 to calculate a usage proportion, and compares the usage proportion with an allocation proportion of the device 12 to determine the device 12 whose usage proportion is higher than the allocation proportion. Then, the adjustment unit 15 controls the device 12 whose usage proportion is determined to be higher than the allocation proportion so that the bandwidth usage is reduced.

Next, the management unit 20 will be described. As illustrated in FIG. 1, the management apparatus 20 includes the management unit 21. The management unit 21 is realized by executing a program of orchestration software.

The management unit 21 controls an application to be executed in a virtualization resource (container, VM, or the like). The virtualization resources are set in each server 10.

The application requests a physical resource amount to the management unit 21. For example, the application requests the management unit 21 how much physical resources are required, such as “3 cores” for the CPU, “4 GB” for the memory, and “1” for the GPU.

In addition, the application requests the management unit 21 for the logical resource amount. For example, the application requests the management unit 21 how much logical resource amount is required for each device, as shown in “3 (in a case where App-α requests the logical resource amount of the device 12 of the device type “X”)”, or “4 (in a case where App-α requests the logical resource amount of the device 12 of device type “Y”) as the logical resource amount of the connection IF 13 bandwidth.

The management unit 21 finds a server 10 satisfying the conditions of the requested physical resource amount and logical resource amount in the empty server group, and allocates a VM or a container to the found server 10. Then, after the VM or the container is deployed in the server 10, the application is executed. While the application is executed, the monitoring unit 14 monitors the bandwidth usage of the connection IF 13, and the adjustment unit 15 adjusts the usage in a case where the bandwidth usage exceeds the upper limit. The adjustment unit 15 transmits/receives information necessary for adjusting the bandwidth usage to/from the management unit 21.

### Adjustment Processing of Bandwidth Usage in Information Processing System

Next, a flow of adjustment processing of the bandwidth usage executed by the information processing system 1 according to the present embodiment will be described.

The adjustment processing of the bandwidth usage of the connection IF 13 is preferably selected in accordance with a method which can be set in the device 12. Hereinafter, the adjustment processing of the bandwidth usage will be described in cases of <1>a device that can directly adjust the bandwidth usage of the connection IF 13 by changing the settings of the device 12 (referred to as the “first device”) and <2>of a device that can indirectly adjust the bandwidth usage of the connection IF 13 by controlling the throughput of the device 12 (referred to as a “second device”).

<1>Adjustment processing of the device capable of directly adjusting the bandwidth usage of the connection IF 13 by changing the setting of the device 12 (first device) In a case where the setting value of the device 12 itself is equal to the bandwidth amount of the connection IF 13 to be used, such as a network interface card (NIC), or in a case where the device 12 can directly set the bandwidth amount of the connection IF 13, the bandwidth usage of the connection IF 13 is adjusted by changing the setting of the device 12. The adjustment unit 15 performs control to reduce a bandwidth usable by the first device 12 in a case where the bandwidth usage of the connection IF 13 exceeds an upper limit. Thus, for example, since the amount of data inputted through the NIC can be reduced, the amount of data flowing through the connection IF 13 can be also inevitably reduced.

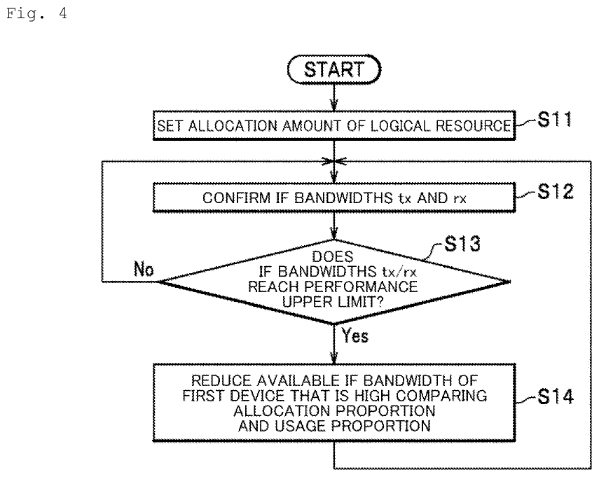

Referring to FIG. 4 (as appropriate, referring to FIGS. 1 to 3), the bandwidth adjustment processing for the first device 12 will be described. FIG. 4 illustrates a flowchart (first device) of an information processing method according to the present embodiment.

The management unit 21 of the management apparatus 20 sets an allocation amount of logical resources when deploying the container (step S11). For example, in a case where it is assumed that “App-α” and “App-β” are executed by “Server A” which is the first server 10A, the management unit 21 allocates “3” as a logical resource amount to the device 12 of the device type “X” used in “App-α”, allocates “4” as a logical resource amount to the device 12 of a device type “Y” used in “App-α”, and allocates “3” as a logical resource amount to the device 12 of the device type “Z” used in “App-β”. Then, the application is executed based on the allocated logical resource amount.

After the execution of the application is started, the monitoring unit 14 of the server 10 confirms the bandwidth usage on the transmission side and the reception side of the connection IF 13 (step S12). In FIG. 4, the bandwidth usage on the transmission side is denoted as “tx”, and the bandwidth usage on the reception side is denoted as “rx”. Subsequently, the monitoring unit 14 determines whether the bandwidth usage on the transmission side or the reception side reaches the upper limit of performance (step S13). In a case where the performance upper limit is not reached (“No” in step S13), since no competition occurs, no adjustment is performed, and the processing is advanced to step S12 to continuously confirm the bandwidth usage.

On the other hand, in a case where the performance upper limit is reached (“Yes” in step S13), the adjustment unit 15 of the server 10 compares the allocation proportion with the usage proportion, and reduces the bandwidth of the available connection IF 13 of the first device 12 whose the usage proportion is high (step S14). For example, in a case where the usage proportion is “ 4/10 (40%)” with respect to the allocation proportion “ 3/10 (30%)” of the first device 12 used in “App-α”, the bandwidth available for the first device 12 is reduced. Then, the processing is advanced to step S12 to continuously confirm the bandwidth usage.

<2>Adjustment processing of the device (second device) capable of indirectly adjusting the bandwidth usage of the connection IF 13 by controlling the throughput of the device

In a case where the device 12 is an arithmetic device such as GPU, FPGA, ASIC, or the like, throughput of processing is controlled to adjust the bandwidth usage of the connection IF 13. The adjustment unit 15 performs control at least one of a control to reduce the number of arithmetic units of the second device 12 and a control to lower the operation clock, in case where the usage amount of the connection IF 13 exceeds the upper limit. Thus, since the amount of data to be subjected to arithmetic processing can be reduced, the amount of data flowing through the connection IF 13 can be also inevitably reduced.

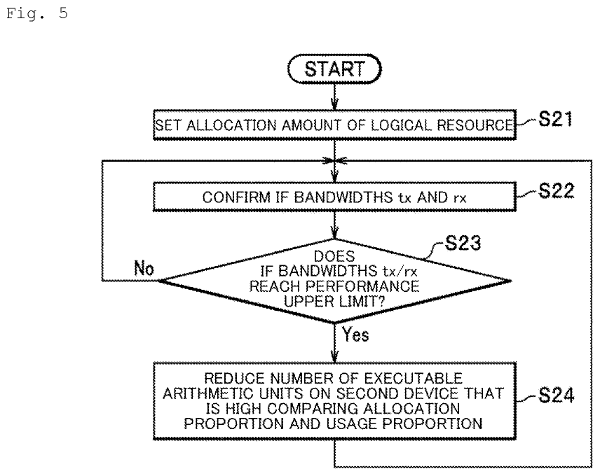

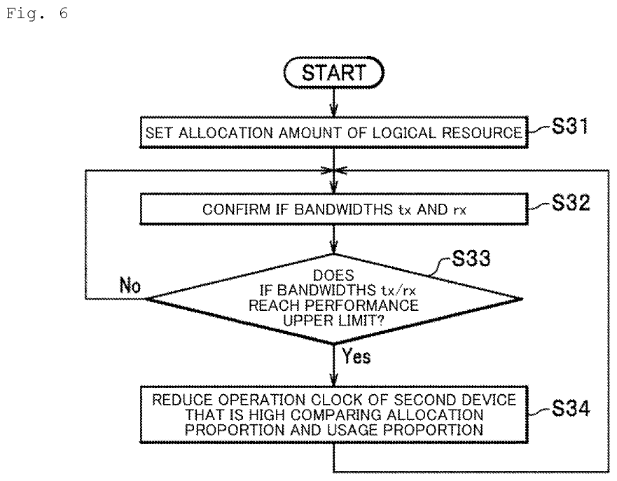

Referring to FIGS. 5 and 6 (as appropriate, referring to FIGS. 1 to 4), the bandwidth adjustment processing for the second device 12 will be described. FIGS. 5 and 6 illustrate flowcharts (second device) of an information processing method according to the embodiment.

The processing from step S21 to step S23 in FIG. 5 is similar to the processing from step S11 to S13 in FIG. 4. Therefore, the description of the processing of these steps will be omitted. In a case where the performance upper limit is reached in the determination of step S23 (“Yes” in step S23), the adjustment unit 15 of the server 10 compares the allocation proportion with the usage proportion, and reduces the number of executable arithmetic units of the second device 12 whose the usage proportion is high (step S24). For example, in a case where the usage proportion is “ 4/10 (40%)” with respect to the allocation proportion “ 3/10 (30%)” of the second device 12 used in “App-α”, the number of executable arithmetic units of the second device 12 is reduced. Then, the processing is advanced to step S22 to continuously confirm the bandwidth usage.

The processing from step S31 to step S33 in FIG. 6 is similar to the processing from step S11 to step S13 in FIG. 4. Therefore, the description of the processing of these steps will be omitted. In a case where the performance upper limit is reached in the determination of step S33 (“Yes” in step S33), an adjustment unit 15 of the server 10 compares the allocation proportion with the usage proportion to lower the operation clock of the second device 12 whose the usage proportion is high (step S34). For example, in a case where the usage proportion is “ 4/10 (40%)” with respect to the allocation proportion “ 3/10 (30%)” of the second device 12 used in “App-α”, the operation clock of the second device 12 is reduced. Then, the processing is advanced to step S32 to continuously confirm the bandwidth usage.

In addition, in a case where the device 12 is an arithmetic device such as a GPU, an FPGA, and an ASIC, the adjustment unit 15 may perform processing in which control for reducing the number of arithmetic units of the second device 12 and control for lowering the operation clock are combined.

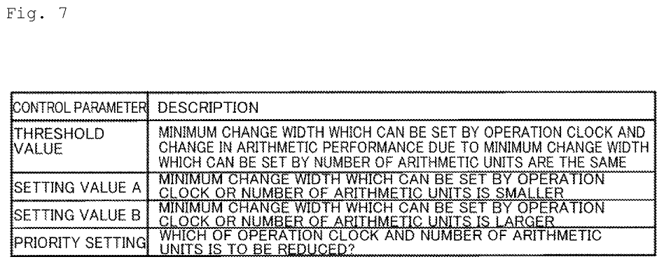

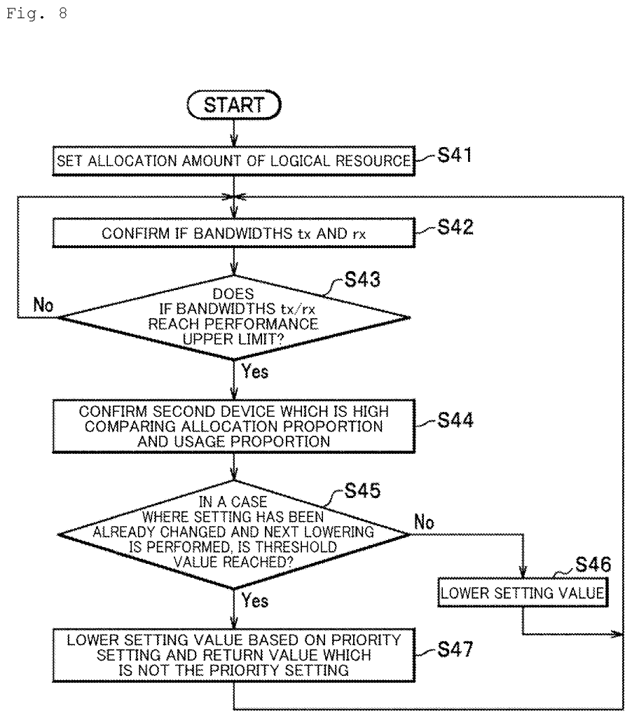

With reference to FIGS. 7 and 8 (as appropriate, with reference to FIGS. 1 to 6), the bandwidth adjustment processing by the combination method for the second device 12 will be described. FIG. 7 is a list of parameters to be set in the adjustment processing of the combination system. FIG. 8 illustrates a flowchart (second device) the information processing method according to the present embodiment.

Here, it is assumed that the arithmetic device has an operating frequency of about “1.5 GHZ” and the number of arithmetic units of about “108”, for example. The operation clock can be set in the unit of “100 MHz” in many cases, and the minimum change width accompanying the setting is about “5 to 10%”. Further, assuming that the number of arithmetic units is “NVIDIA Multi-Instance GPU”, the minimum change width associated with the setting is about “15%”.

The parameter of “threshold value” illustrated in FIG. 7 is a value in which a change in arithmetic performance due to the minimum change width that can be set by the operation clock becomes equal to a change in arithmetic performance due to a minimum change width that can be set by the number of arithmetic units. For example, in a case where the minimum change width of the operation clock is “5%” and the minimum change width according to the number of arithmetic units is “15%”, the threshold value is “15%”.

The parameter of the “setting value A” is a setting value having the smaller minimum change width which can be set by the operation clock or the number of arithmetic units. Here, since the minimum change width of the operation clock is smaller in this example, the setting value A is the setting value of the operation clock.

The parameter of the “setting value B” is a setting value having the larger minimum change width which can be set by the operation clock or the number of arithmetic units. Here, since the minimum change width of the number of arithmetic units is larger, the setting value B is the setting value of the number of arithmetic units.

The parameter of “priority setting” is information indicating which of the operation clock and the number of arithmetic units is to be reduced in a specific situation. Here, in this case, the bandwidth usage is adjusted with finer granularity using a smaller settable minimum change width (operation clock), thereby minimizing the effect of performance. In the case of setting change exceeding the threshold value, the bandwidth usage is adjusted based on preset priority setting (for example, the number of arithmetic units), thereby minimizing performance influence in accordance with the characteristics of the application. The details of the priority setting processing are as illustrated in FIG. 8.

The processing from step S41 to step S43 in FIG. 8 is similar to the processing from step S11 to step S13 according in FIG. 4. Therefore, the description of the processing of these steps will be omitted. In a case where the performance upper limit is reached in the determination of step S43 (“Yes” in step S43), the adjustment unit 15 of the server 10 compares the allocation proportion with the usage proportion to confirm the second device 12 whose the usage proportion is high (step S44).

Subsequently, the adjustment unit 15 has already changed the setting of the confirmed second device 12, and determines whether the second device 12 reaches a threshold value in a case where the setting is lowered next (step S45). In the case of “No” in step S45, the adjustment unit 15 lowers the setting of the smaller minimum change width based on the “setting value A” of the parameter (step S46). On the other hand, in the case of “Yes” in step S45, the adjustment unit 15 lowers the setting value based on the priority setting and returns a value which is not the priority setting (step S47).

For example, in a case where the bandwidth usage first reaches the upper limit, the operation clock is lowered to adjust the bandwidth usage, and accordingly, the calculation performance is lowered by the minimum variation width “5%”. In a case where the bandwidth usage reaches the upper limit next, since the threshold value does not reach the threshold value “15%” even if the arithmetic performance is lowered, the operation clock is further lowered to adjust the bandwidth usage, and accordingly, the arithmetic performance is lowered by the minimum change width “5%”, and the total change amount becomes “10%”. In a case where the bandwidth usage reaches the upper limit next, when the arithmetic performance is lowered, it reaches a threshold value “15%”, so that the number of arithmetic units is reduced to adjust the bandwidth usage, and the setting of the operation clock is returned to eliminate the deterioration of the arithmetic performance due to the operation clock. Accordingly, the arithmetic performance is lowered by the minimum change width “15%” by setting the number of arithmetic units. In a case where the bandwidth usage further reaches the next upper limit, even if the calculation performance is lowered, the threshold value “15%” will not be reached (because the operating clock setting was returned), the operation clock is lowered to adjust the bandwidth usage, and as a result, the arithmetic performance is lowered by the minimum change width “5%”, and the total change amount becomes “20%”. It is also possible to always adjust the bandwidth usage by setting the operation clock by setting the priority setting as the operation clock. Thus, the bandwidth usage can be adjusted with fine granularity, and setting can be changed according to the characteristics of the application. For example, it is possible to respond to a request that the operation clock is not desired to be lowered more than necessary due to the characteristics of the application.

### Hardware Configuration

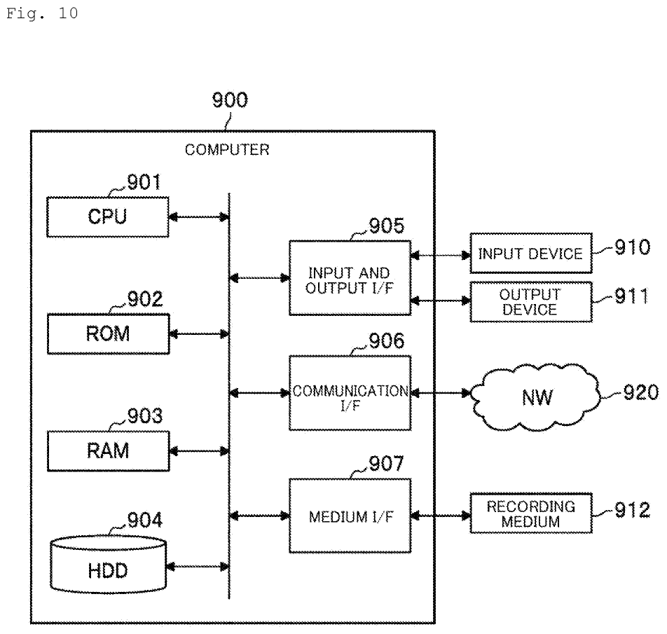

The server 10 (information processing apparatus) according to the present embodiment is realized by, for example, a computer 900 having a configuration as illustrated in FIG. 10.

FIG. 10 is a hardware configuration diagram showing an example of a computer 900 that realizes the functions of the server 10 (information processing apparatus) according to the present embodiment. The computer 900 has a CPU 901, a Read Only Memory (ROM) 902, a RAM 903, a Hard Disk Drive (HDD) 904, an input-output Interface (I/F) 905, a communication I/F 906, and a media I/F 907.)

The CPU 901 operates based on a program stored in the ROM 902 or the HDD 904 and causes the control unit to perform control. The ROM 902 stores a boot program executed by the CPU 901 when the computer 900 is activated, a program related to the hardware of the computer 900, and the like.

The CPU 901 controls an input device 910 such as a mouse and a keyboard, and an output device 911 such as a display and a printer through the input/output I/F 905. The CPU 901 acquires data from the input device 910 through the input/output I/F 905 and outputs the generated data to the output device 911. Note that a GPU or the like may be used together with the CPU 901 as the processor.

The HDD 904 stores a program executed by the CPU 901, data used by the program, and the like. The communication I/F 906 receives data from other devices through a communication network (e.g., a NW (Network) 920), outputs said data to the CPU 901, and transmits data generated by the CPU 901 to other devices through the communication network.

The medium I/F 907 reads a program or data stored in recording medium 912 and outputs it to the CPU 901 through the RAM 903. The CPU 901 loads a program related to desired processing from the recording medium 912 onto the RAM 903 through the medium I/F 907, and executes the loaded program. The recording medium 912 is an optical recording medium such as a digital versatile disc (DVD) or a phase change rewritable disk (PD), a magnetooptic recording medium such as a magneto optical disk (MO), a magnetic recording medium, a semiconductor memory, or the like.

For example, in a case where the computer 900 serves as the server 10 (information processing apparatus) of the present invention, the CPU 901 of the computer 900 realizes the functions of the server 10 (information processing apparatus)) by executing a program loaded on the RAM 903. Further, data in the RAM 903 is stored in the HDD 904. The CPU 901 reads a program related to target processing from the recording medium 912 and executes the program. In addition, the CPU 901 may read a program related to desired processing from other devices through the communication network (NW 920).

### Effects

Hereinafter, the effects of the information processing apparatus and the like according to the present invention will be described.

An information processing apparatus according to the present invention is the server 10 capable of executing an application of either a container or a virtual machine, and includes the CPU 11, the connection IF 13 for connecting a plurality of devices 12 to the CPU 11, the monitoring unit 14 that monitors whether a bandwidth usage of the connection IF 13 exceeds an upper limit, and the adjustment unit 15 that adjusts the bandwidth usage in a case where the usage exceeds the upper limit, in which the bandwidth has a defined logical resource amount, the allocation proportion associated with the device 12 is set based on the logical resource amount, and the adjustment unit 15 performs control so that the bandwidth usage is reduced with respect to the one in which the usage proportion of the bandwidth is higher than the allocation proportion.

According to the server 10 as the information processing apparatus, the logical resource amount is defined in the bandwidth of the connection IF 13, and the bandwidth usage can be adjusted by using the logical resource amount. Thus, it is possible to prevent the usage of the connection IF 13 from exceeding the upper limit, and to suppress competition caused by shortage of the bandwidth of the connection IF 13. As a result, it becomes possible to guarantee the performance of the application. In addition, the present invention can be used for general purposes without depending on the implementation of an application.

In addition, the device 12 is a first device capable of adjusting the bandwidth usage of the connection IF 13 by changing the setting of the device 12, and the adjustment unit 15 performs control for reducing the available bandwidth in a case where the usage exceeds the upper limit.

Thus, even in a case where the device 12 such as NIC is connected to the CPU 11, the bandwidth usage can be appropriately adjusted.

In addition, the device 12 is a second device capable of adjusting the bandwidth usage of the connection IF 13 by controlling the throughput of the device 12, and the adjustment unit 15 performs at least one of a control to reduce the number of arithmetic units and a control to lower the operating clock in a case where the usage amount exceeds the upper limit.

Thus, even in a case where the device 12 such as a GPU, an FPGA, and an ASIC is connected to the CPU 11, the bandwidth usage can be appropriately adjusted.

In addition, a minimum change width of a change in arithmetic performance due to control for reducing the number of arithmetic units is different from a minimum change width of a change in arithmetic performance due to control for lowering the operation clock, and a value at which a change amount in a case where a setting value having a smaller minimum change width is lowered is equal to a change amount in a case where a setting value having a larger minimum change width is lowered is set as a threshold value, priority setting in which priority is registered between control for reducing the number of arithmetic units and control for lowering the operation clock is performed, and the adjustment unit 15 gradually decreases the setting value having a smaller minimum change width in a case where the usage amount exceeds an upper limit, and then in a case where the smaller minimum change width reaches the threshold value by decreasing the set value, decreases the set value of the value that has been prioritized and returns the other set value to the initial state.

Thus, in a case where the device 12 such as a GPU, an FPGA, an ASIC is connected to the CPU 11, the bandwidth usage is adjusted with fine particle size, the setting can be changed in accordance with the characteristics of the application.

Note that the present invention is not limited to the embodiment described above, and various modifications can be made by a person of ordinary skill in the art within the technical idea of the present invention.

### REFERENCE SIGNS LIST

1 Information processing system
10, 10A, 10B, 10C Server (information processing apparatus)
11 CPU
12 Device
13 Connection IF
14 Monitoring unit
15 Adjustment unit
20 Management apparatus
21 Management unit

1. An information processing apparatus capable of executing an application of any one of a container and a virtual machine, the apparatus comprising:
a CPU;
a connection interface (IF) for connecting a plurality of devices to the CPU;
a monitoring unit configured to monitor whether a bandwidth usage of the connection IF exceeds an upper limit; and
an adjustment unit configured to adjust the bandwidth usage in a case where the usage exceeds the upper limit, wherein
in the bandwidth, a logical resource amount is defined and an allocation proportion associated with the device is set based on the logical resource amount, and
the adjustment unit is configured to perform control such that the bandwidth usage is reduced for a case where a usage proportion of the bandwidth is higher than an allocation proportion.

2. The information processing apparatus according to claim 1, wherein the device is a first device capable of adjusting the bandwidth usage of the connection IF by changing the setting of the device, and
the adjustment unit is configured to perform control to reduce the available bandwidth in a case where the usage exceeds an upper limit.

3. The information processing apparatus according to claim 1, wherein
the device is a second device capable of adjusting the bandwidth usage of the connection IF by controlling a throughput of the device, and
the adjustment unit is configured to perform one of a control to reduce the number of arithmetic units and a control to lower an operating clock in a case where the usage exceeds an upper limit.

4. The information processing apparatus according to claim 3, wherein
a minimum change width of a change in arithmetic performance due to control for reducing the number of arithmetic units is different from a minimum change width of a change in arithmetic performance due to control for lowering the operation clock, and a value at which a change amount in a case where a setting value having a smaller minimum change width is lowered is equal to a change amount in a case where a setting value having a larger minimum change width is lowered is set as a threshold value,
priority setting in which priority is registered between control for reducing the number of arithmetic units and control for lowering the operation clock is performed, and
the adjustment unit is configured to gradually decrease the setting value having a smaller minimum change width in a case where the usage amount exceeds an upper limit, and then in a case where the smaller minimum change width reaches the threshold value by decreasing the set value, decrease the set value of the value that has been prioritized and returns the other set value to the initial state.

5. An information processing method of an information processing apparatus capable of executing an application of one of a container and a virtual machine, wherein
the information processing device includes
a CPU, and a connection IF connecting a plurality of devices to the CPU, the method comprising:
a monitoring step of monitoring whether a bandwidth usage of the connection IF exceeds an upper limit; and
an adjustment step of adjusting the bandwidth usage in a case where the usage exceeds the upper limit, wherein
in the bandwidth, a logical resource amount is defined and an allocation proportion associated with the device is set based on the logical resource amount, and the adjustment step comprises:
performing control such that the bandwidth usage is reduced for a case where a usage proportion of the bandwidth is higher than an allocation proportion.

6. A non-transitory computer-readable storage medium storing a program for causing a computer to perform operations of an information processing apparatus capable of executing an application of one of a container and a virtual machine, the operations comprising:
a monitoring step of monitoring whether a bandwidth usage of a connection IF exceeds an upper limit; and
an adjustment step of adjusting the bandwidth usage in a case where the usage exceeds the upper limit, wherein
in the bandwidth, a logical resource amount is defined and an allocation proportion associated with the device is set based on the logical resource amount, and the adjustment step comprises:
performing control such that the bandwidth usage is reduced for a case where a usage proportion of the bandwidth is higher than an allocation proportion.

7. The information processing method according to claim 5, wherein the device is a first device capable of adjusting the bandwidth usage of the connection IF by changing the setting of the device, and the method further comprises:
performing control to reduce the available bandwidth in a case where the usage exceeds an upper limit.

8. The information processing method according to claim 5, wherein
the device is a second device capable of adjusting the bandwidth usage of the connection IF by controlling a throughput of the device, and
the method further comprises performing one of a control to reduce the number of arithmetic units and a control to lower an operating clock in a case where the usage exceeds an upper limit.

9. The information processing method according to claim 8, wherein
a minimum change width of a change in arithmetic performance due to control for reducing the number of arithmetic units is different from a minimum change width of a change in arithmetic performance due to control for lowering the operation clock, and a value at which a change amount in a case where a setting value having a smaller minimum change width is lowered is equal to a change amount in a case where a setting value having a larger minimum change width is lowered is set as a threshold value,
priority setting in which priority is registered between control for reducing the number of arithmetic units and control for lowering the operation clock is performed, and
the method further comprises gradually decreasing the setting value having a smaller minimum change width in a case where the usage amount exceeds an upper limit, and then in a case where the smaller minimum change width reaches the threshold value by decreasing the set value, decreasing the set value of the value that has been prioritized and returns the other set value to the initial state.
